(19) United States
(12) Patent Application Publication
(10) Pub. No.: US 2011/0052992 A1
(43) Pub. Date: Mar. 3, 2011

(54) ACTIVE MATERIAL, LITHIUM-ION SECONDARY BATTERY, AND METHOD OF MANUFACTURING ACTIVE MATERIAL

(75) Inventors: Atsushi SANO, Tokyo (JP); Keitaro OTSUKI, Tokyo (JP); Yosuke MIYAKI, Tokyo (JP); Takeshi TAKAHASHI, Tokyo (JP); Akiji HIGUCHI, Kyoto-shi (JP)

(73) Assignee: TDK CORPORATION, Tokyo (JP)

(21) Appl. No.: 12/855,976

(22) Filed: Aug. 13, 2010

(30) Foreign Application Priority Data
Aug. 25, 2009 (JP) P2009-194583

(51) Int. Cl. H01M 4/485; C01B 25/30

(52) U.S. Cl. 429/231.2; 423/306; 428/401

(57) ABSTRACT

An active material which can improve the discharge capacity of a lithium-ion secondary battery is provided. The active material of the present invention contains a rod-shaped particle group having a β-type crystal structure of LiVOPO₄. The particle group has an average minor axis length S of 1 to 5 μm, an average major axis length L of 2 to 20 μm, and L/S of 2 to 10.

### BACKGROUND OF THE INVENTION

1. Field of the Invention

The present invention relates to an active material, a lithium-ion secondary battery, and a method of manufacturing the active material.

2. Related Background Art

Laminar compounds such as LiCoO₂ and LiNi_{1/3}Mn_{1/3}Co_{1/3}O₂ and spinel compounds such as LiMn₂O₄ have conventionally been used as positive electrode materials (positive electrode active materials) of lithium-ion secondary batteries. Attention has recently been focused on compounds having olivine-type structures such as LiFePO₄. Positive electrode materials having the olivine structure have been known to exhibit high thermal stability at high temperature, thereby yielding high safety. However, lithium-ion secondary batteries using LiFePO₄ have drawbacks in that their charge/discharge voltage is low, i.e., about 3.5 V, whereby their energy density decreases. Therefore, LiCoPO₄, LiNiPO₄, and the like have been proposed as phosphate-based positive electrode materials which can achieve high charge/discharge voltage. Nevertheless, lithium-ion secondary batteries using these positive electrode materials have not attained sufficient capacities yet. Among the phosphate-based positive electrode materials, LiVOPO₄ has been known as a compound which can achieve a 4-V-class charge/discharge voltage. However, lithium-ion secondary batteries using LiVOPO₄ have not attained sufficient reversible capacity and rate characteristic yet, either. The above-mentioned positive electrode materials are described, for example, in Japanese Patent Application Laid-Open Nos. 2003-68304 and 2004-303527; J. Solid State Chem., 95, 352 (1991); N. Dupre et al., Solid State Ionics, 140, pp. 209-221 (2001); N. Dupre et al., J. Power Sources, 97-98, pp. 532-534 (2001); J. Baker et al., J. Electrochem. Soc., 151, A796 (2004); and Electrochemistry, 71, 1108 (2003). In the following, a lithium-ion secondary battery will be referred to as “battery” as the case may be.

### SUMMARY OF THE INVENTION

In view of the problems of the prior art mentioned above, it is an object of the present invention to provide an active material, a lithium-ion secondary battery, and a method of manufacturing the active material which can improve the discharge capacity of a lithium-ion secondary battery.

For achieving the above-mentioned object, the active material in accordance with the present invention contains a rod-shaped particle group having a β-type crystal structure of LiVOPO₄. The particle group contained in the active material in accordance with the present invention has an average minor axis length S of 1 to 5 μm, an average major axis length L of 2 to 20 μm, Wand L/S of 2 to 10. The lithium-ion secondary battery in accordance with the present invention has a positive electrode comprising a positive electrode current collector and a positive electrode active material layer disposed on the positive electrode current collector, while the positive electrode active material layer contains the active material in accordance with the present invention.

The lithium-ion secondary battery including the active material in accordance with the present invention as the positive electrode active material can improve the discharge capacity as compared with a lithium-ion secondary battery using conventional LiVOPO₄ having a β-type crystal structure.

The method of manufacturing an active material in accordance with the present invention comprises a hydrothermal synthesis step of heating a mixture containing a lithium source, a phosphate source, a vanadium source, water, and a reducing agent under pressure. In the method of manufacturing an active material in accordance with the present invention, the hydrothermal synthesis step adjusts the ratio [P]/[V] of the number of moles of phosphorus [P] contained in the mixture before heating to the number of moles of vanadium [V] contained in the mixture before heating to 2 to 9.

The method of manufacturing an active material in accordance with the present invention can form the active material in accordance with the present invention.

In the method of manufacturing an active material in accordance with the present invention, the hydrothermal synthesis step may adjust the ratio [Li]/[V] of the number of moles of lithium [Li] contained in the mixture before heating to [V] to 0.9 to 1.1. Effects of the present invention can also be obtained when [Li]/[V] is greater than 1.1, though.

The present invention can provide an active material, a lithium-ion secondary battery, and a method of manufacturing the active material which can improve the discharge capacity of a lithium-ion secondary battery.

### BRIEF DESCRIPTION OF THE DRAWINGS

FIG. 1 is a photograph of the active material of Example 1 in accordance with the present invention taken through a scanning electron microscope (SEM); and FIG. 2 is a schematic sectional view of a lithium-ion secondary battery having a positive electrode active material layer containing the active material in accordance with an embodiment of the present invention.

### DESCRIPTION OF THE PREFERRED EMBODIMENTS

In the following, preferred embodiments of the present invention will be explained in detail with reference to the drawings.

Active Material

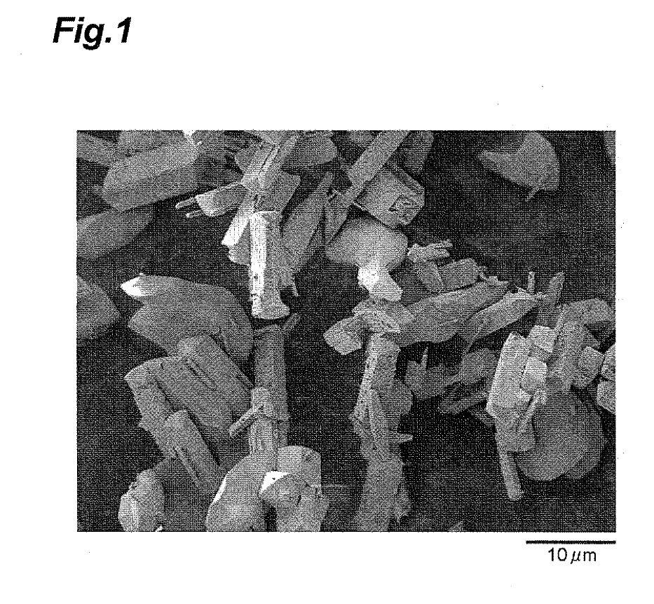

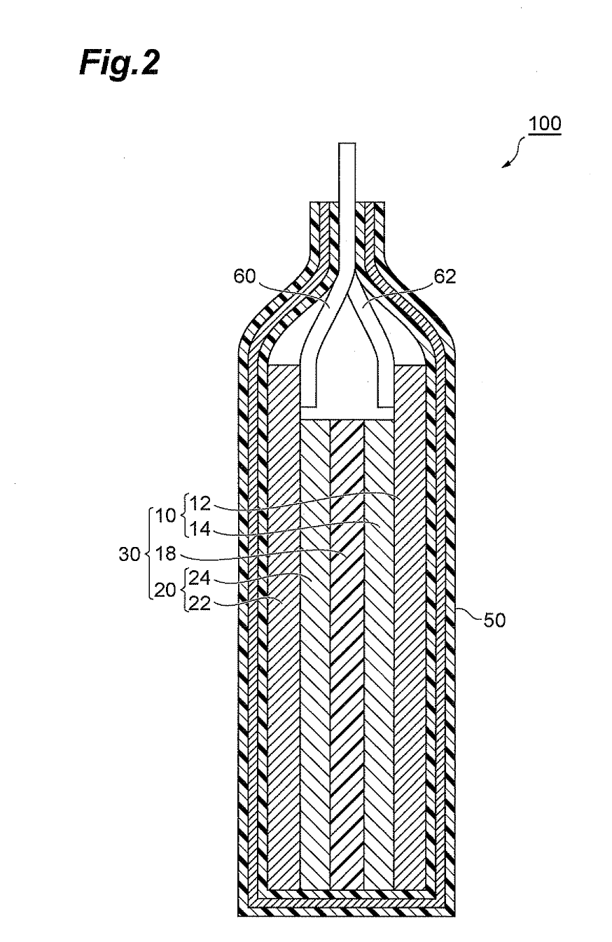

As illustrated in FIG. 1, the active material in accordance with an embodiment contains a rod-shaped particle group having a β-type crystal structure of LiVOPO₄. That is, each of the particles contained in the active material in accordance with this embodiment is a rod-shaped β-type crystal of LiVOPO₄.

The particle group has an average minor axis length S of 1 to 5 μm. When the average length S is too small, sufficient orientation may not be attained; which tends to block lithium diffusion paths, thereby lowering the discharge capacity. When the average length S is too large, the diffusion of lithium tends to become slower, thereby lowering the discharge capacity.

The particle group has an average major axis length L of 2 to 20 μm. When the average length L is too small, sufficient orientation may not be attained, which tends to block lithium diffusion paths, thereby lowering the discharge capacity. When the average length L is too large, the diffusion of lithium tends to become slower, thereby lowering the discharge capacity.

L/S is 2 to 10. When L/S is outside of the range of 2 to 10, the discharge capacity becomes lower than that in the case where L/S is 2 to 10. When L/S is outside of the range of 2 to 10, the rate characteristic also becomes inferior to that in the case where L/S is 2 to 10. Both the discharge capacity and rate characteristic can be improved only when L/S is 2 to 10.

The active material in accordance with this embodiment is suitable as a positive electrode active material of a lithium-ion secondary battery.

As illustrated in FIG. 2, a lithium-ion secondary battery 100 in accordance with this embodiment comprises a power generating element 30 including planar negative and positive electrodes 20, 10 opposing each other and a planar separator 18 arranged between and adjacent to the negative and positive electrodes 20, 10, an electrolytic solution containing lithium ions, a case 50 accommodating them in a closed state, a negative electrode lead 60 having one end part electrically connected to the negative electrode 20 and the other end part projecting out of the case, and a positive electrode lead 62 having one end part electrically connected to the positive electrode 10 and the other end part projecting out of the case.

The negative electrode 20 has a negative electrode current collector 22 and a negative electrode active material layer 24 formed on the negative electrode current collector 22. The positive electrode 10 has a positive electrode current collector 12 and a positive electrode active material layer 14 formed on the positive electrode current collector 12. The separator 18 is located between the negative and positive electrode active material layers 24, 14.

The positive electrode active material layer 14 contains the active material in accordance with this embodiment.

In general, LiVOPO₄ has been known to exhibit a plurality of crystal structures such as triclinic crystal (α-type crystal) and rhombic crystal (β-type crystal) and have different electrochemical characteristics depending on their crystal structures. The (β-type crystal of LiVOPO₄ has an ion conduction path (lithium ion path) more linear and shorter than that of the α-type crystal and thus is excellent in reversibly inserting and desorbing lithium ions (hereinafter referred to as “reversibility” as the case may be). Therefore, a battery using the active material in accordance with this embodiment containing the β-type crystal of LiVOPO₄ satisfying the conditions concerning L and S mentioned above has a greater charge/discharge capacity and superior rate characteristic than a battery using the α-type crystal.

Method of Manufacturing Active Material

The method of manufacturing an active material in accordance with an embodiment of the present invention will now be explained. The method of manufacturing an active material in accordance with this embodiment can form the active material in accordance with the above-mentioned embodiment.

Hydrothermal Synthesis Step

The method of manufacturing an active material in accordance with this embodiment comprises the following hydrothermal synthesis step. The hydrothermal synthesis step initially puts a lithium source, a phosphate source, a vanadium source, water, and a reducing agent into a reaction vessel (e.g., an autoclave) having functions to heat and pressurize the inside thereof, so as to prepare a mixture (aqueous solution) in which they are dispersed. When preparing the mixture, for example, a mixture of the phosphate source, vanadium source, water, and reducing agent may be refluxed, and then the lithium source may be added thereto. This reflux can form a complex of the phosphate source and vanadium source.

As the lithium source, at least one species selected from the group consisting of LiNO₃, Li₂CO₃, LiOH, LiCl, Li₂SO₄, and CH₃COOLi can be used, for example.

Preferably, the lithium source is at least one species selected from the group consisting of LiOH, Li₂CO₃, CH₃COOLi, and Li₃PO₄. This can improve the discharge capacity and rate characteristic of a battery as compared with the case using Li₂SO₄.

As the phosphate source, at least one species selected from the group consisting of H₃PO₄, NH₄H₂PO₄, (NH₄)₂HPO₄, and Li₃PO₄ can be used, for example.

As the vanadium source, at least one species selected from the group consisting of V₂O₅ and NH₄VO₃ can be used, for example.

Two or more species of the lithium source, two or more species of the phosphate source, or two or more species of the vanadium source may be used together.

As the reducing agent, at least one of hydrazine (NH₂NH₂·H₂O) and hydrogen peroxide (H₂O₂), for example, can be used. Preferably, hydrazine is used as the reducing agent. Using hydrazine tends to improve the discharge capacity and rate characteristic of a battery remarkably as compared with the cases using other reducing agents.

If the mixture contains no reducing agent, the resulting particle group will become particulate or indefinite instead of being shaped like rods. When the mixture contains no reducing agent, the particle group tends to have an average minor axis length S of less than 1 μm, an average major axis length L of less than 2 μm, and L/S of less than 2. A battery using an active material formed without the reducing agent exhibits smaller discharge capacity and inferior rate characteristic as compared with the battery using the active material in accordance with this embodiment.

Before heating the mixture under pressure, the hydrothermal synthesis step adjusts the ratio [P]/[V] of the number of moles of phosphorus [P] contained in the mixture to the number of moles of vanadium [V] contained in the mixture to 2 to 9. [P]/[V] may be adjusted by the compounding ratio between the phosphate source and vanadium source contained in the mixture.

When [P]/[V] is too small, the resulting particle group becomes particulate instead of being shaped like rods. Also, when [P]/[V] is too small, L/S in the active material becomes less than 2. Therefore, the discharge capacity is harder to increase when [P]/[V] is too small than when [P]/[V] is 2 to 9.

When [P]/[V] is too large, L/S in the active material becomes greater than 10. Therefore, the discharge capacity is harder to increase when [P]/[V] is too large than when [P]/[V] is 2 to 9.

Before heating the mixture under pressure, the hydrothermal synthesis step may adjust the ratio [Li]/[V] of the number of moles of lithium [Li] contained in the mixture to [V] to 0.9 to 1.1. Effects of the present invention can also be obtained when [Li]/[V] is greater than 1.1, though. [Li]/[V] may be adjusted by the compounding ratio between the lithium source and vanadium source contained in the mixture.

It has been necessary for conventional methods of manufacturing LiVOPO₄ to adjust [Li]/[V] to a value (e.g., 9) greater than 1 which is a stoichiometric ratio of LiVOPO₄ in order to inhibit Li from lacking in LiVOPO₄ obtained. By contrast, this embodiment can yield LiVOPO₄ with high crystallinity without deficiency of Li even when [Li]/[V] is adjusted to 0.9 to 1.1 near the stoichiometric ratio of LiVOPO₄.

Preferably, before heating the mixture under pressure, the hydrothermal synthesis step adjusts the pH of the mixture to less than 4. This makes it easier for a β-type crystal phase of LiVOPO₄ to occur, whereby the discharge capacity tends to improve remarkably.

For adjusting the pH of the mixture, various methods can be employed, an example of which is adding an acidic or alkaline reagent to the mixture. Examples of the acidic reagent include nitric acid, hydrochloric acid, and sulfuric acid. An example of the alkaline reagent is an aqueous ammonia solution. The pH of the mixture varies depending on the amount of the mixture and the species or compounding ratio of the lithium source, phosphate source, and vanadium source. Therefore, the amount of the acidic or alkaline reagent to be added may be adjusted according to the amount of the mixture and the species or compounding ratio of the lithium source, phosphate source, and vanadium source as appropriate.

The hydrothermal synthesis step heats the mixture while pressurizing it in a closed reaction vessel, so that a hydrothermal reaction proceeds in the mixture. This hydrothermally synthesizes the β-type crystal of LiVOPO₄. The time for heating the mixture under pressure may be adjusted according to the amount of the mixture as appropriate.

The hydrothermal synthesis step heats the mixture under pressure preferably at 100 to 300° C., more preferably at 200 to 300° C. As the heating temperature for the mixture is higher, the crystal growth is promoted more, thus making it easier to yield the β-type crystal of LiVOPO₄ having a greater particle size.

The generation and crystal growth of LiVOPO₄ are harder to progress when the temperature of the mixture is too low in the hydrothermal synthesis step than when the temperature of the mixture is high. As a result, LiVOPO₄ lowers its crystallinity, so as to reduce its capacity density, whereby a battery using LiVOPO₄ tends to be hard to increase its discharge density. When the temperature of the mixture is too high, on the other hand, the crystal growth of LiVOPO₄ tends to progress in excess, thereby lowering the Li diffusability. This tends to make it harder to improve the discharge capacity and rate characteristic of a battery using LiVOPO₄ obtained. Also, when the temperature of the mixture is too high, the reaction vessel is required to have high heat resistance, which increases the cost of manufacturing the active material. These tendencies can be suppressed when the temperature of the mixture falls within the range mentioned above.

Preferably, the pressure applied to the mixture in the hydrothermal synthesis step is 0.2 to 1 MPa. When the pressure applied to the mixture is too low, finally obtained LiVOPO₄ tends to decrease its crystallinity, thereby reducing its capacity density. When the pressure applied to the mixture is too high, the reaction vessel is required to have high pressure resistance, which tends to increase the cost of manufacturing the active material. These tendencies can be suppressed when the pressure applied to the mixture falls within the range mentioned above.

Heat Treatment Step

The method of manufacturing an active material in accordance with this embodiment may further comprise a heat treatment step of heating the mixture after the hydrothermal synthesis step. The heat treatment step can cause parts of the lithium source, phosphate source, and vanadium source which did not react in the hydrothermal synthesis step to react among them and promote the crystal growth of LiVOPO₄ generated in the hydrothermal synthesis step. This improves the capacity density of LiVOPO₄, thereby enhancing the discharge capacity and rate characteristic of a battery using the same.

When the mixture is heated in a high-temperature region of 200 to 300° C. by the hydrothermal synthesis step in this embodiment, it becomes easier for the hydrothermal synthesis step by itself to form the β-type crystal of LiVOPO₄ with a sufficient size. Even when the mixture is heated in a low-temperature region of less than 200° C. in the hydrothermal synthesis step, it is possible for the hydrothermal synthesis step to form a desirable active material by itself in this embodiment. When the mixture is heated in the low-temperature region in the hydrothermal synthesis step, however, carrying out the heat treatment step subsequent to the hydrothermal synthesis step tends to promote the synthesis and crystal growth of LiVOPO₄, thereby further improving the effects of the present invention.

Preferably, the heat treatment step heats the mixture at a heat treatment temperature of 400 to 700° C. When the heat treatment temperature is too low, LiVOPO₄ tends to reduce its degree of crystal growth, thereby lowering its degree of improvement in capacity density. When the heat treatment temperature is too high, LiVOPO₄ tends to grow in excess, thereby increasing its particle size. This tends to slow down the diffusion of lithium in the active material, thereby reducing the degree of improvement in the capacity density of the active material. These tendencies can be suppressed when the heat treatment temperature falls within the range mentioned above.

The heat treatment time for the mixture may be 3 to 20 hr. The heat treatment atmosphere in the mixture may be a nitrogen atmosphere, argon atmosphere, or air atmosphere.

The mixture obtained by the hydrothermal synthesis step may be preheated for about 1 to 30 hr at about 60 to 150° C. before heating it in the heat treatment step. The preheating turns the mixture into a powder, thereby removing unnecessary moisture and organic solvent from the mixture. This can prevent LiVOPO₄ from incorporating impurities therein in the heat treatment step and homogenize the particle form.

A battery having LiVOPO₄ obtained by the manufacturing method of this embodiment can improve the discharge capacity as compared with a battery using LiVOPO₄ obtained by the conventional manufacturing method.

The inventors infer that, since LiVOPO₄ obtained by the method of manufacturing an active material in accordance with this embodiment has a single phase of the β-type crystal, a battery using the same improves its discharge capacity. In other words, the method of manufacturing an active material in accordance with this embodiment seems to make it possible to produce the β-type crystal of LiVOPO₄ with a higher yield than that of the conventional manufacturing method.

Though a preferred embodiment of the method of manufacturing an active material in accordance with the present invention has been explained in detail in the foregoing, the present invention is not limited to the above-mentioned embodiment.

For example, the hydrothermal synthesis step may add carbon particles to the mixture before heating. This can produce at least a part of LiVOPO₄ on surfaces of the carbon particles, so as to allow the carbon particles to carry LiVOPO₄. As a result, the electric conductivity of the resulting active material can be improved. Examples of materials constituting the carbon particles include carbon black (graphite) such as acetylene black, activated carbon, hard carbon, and soft carbon.

The active material of the present invention can also be used as an electrode material for an electrochemical device other than lithium-ion secondary batteries. Examples of the electrochemical device include secondary batteries, other than the lithium-ion secondary batteries, such as lithium metal secondary batteries (using an electrode containing the active material in accordance with the present invention as a cathode and metallic lithium as an anode) and electrochemical capacitors such as lithium capacitors. These electrochemical devices can also be used for power supplies for self-propelled micromachines, IC cards, and the like and decentralized power supplies placed on or within printed boards.

The present invention will now be explained more specifically with reference to examples and comparative examples, but is not limited to the following examples.

### EXAMPLE 1

In the making of the active material in Example 1, a mixed liquid containing the following materials was prepared.

Lithium source: 4.24 g (0.10 mol) of LiOH·H₂O (having a molecular weight of 41.96 and a purity of 99 wt %, special grade, manufactured by Nacalai Tesque Inc.)

Phosphate source: 34.59 g (0.30 mol) of H₃PO₄ (having a molecular weight of 98.00 and a purity of 85 wt %, first grade, manufactured by Nacalai Tesque Inc.)

Vanadium source: 9.19 g (0.05 mol) of V₂O₅ (having a molecular weight of 181.88 and a purity of 99 wt %, special grade, manufactured by Nacalai Tesque Inc.)

Water: 200 g of distilled water (for HPLC (High Performance Liquid Chromatography) manufactured by Nacalai Tesque Inc.) with 30 g of distilled water separately used between a glass vessel and an autoclave

Reducing agent: 1.28 g (0.025 mol) of NH₂NH₂·H₂O (having a molecular weight of 50.06 and a purity of 98 wt %, special grade, manufactured by Nacalai Tesque Inc.)

As can be seen from the respective contents of the above-mentioned phosphate source and vanadium source, the ratio [P]/[V] of the number of moles of phosphorus [P] contained in the mixed liquid to the number of moles of vanadium [V] contained in the mixed liquid was adjusted to 3. As can be seen from the respective contents of the above-mentioned lithium source and vanadium source, the ratio [Li]/[V] of the number of moles of lithium [Li] contained in the mixed liquid to the number of moles of vanadium [V] contained in the mixed liquid was adjusted to 1. As can be seen from the content of the lithium source and the amount of distilled water, the concentration of Li⁺ in the mixed liquid was adjusted to 0.5 mol/L. The respective compounded amounts of the above-mentioned materials, when converted into LiVOPO₄ (having a molecular weight of 168.85), stoichiometrically correspond to a yield of about 16.89 g (0.1 mol) of LiVOPO₄.

The above-mentioned mixed liquid was prepared in the following procedure. First, 34.59 g of H₃PO₄ and 200 g of distilled water were put into a 500-mL glass vessel for an autoclave and stirred with a magnetic stirrer. Then, 9.19 g of V₂O₅ were added into the glass vessel, whereupon a yellowish orange liquid phase was obtained therein. While vigorously stirring the liquid phase, 1.28 g of hydrazine monohydrate (NH₂NH₂·H₂O) were added dropwise thereto. As hydrazine monohydrate was added dropwise, the liquid phase bubbled and changed its color from yellowish orange to green. The pH of the liquid phase at this moment was 2 to 3. After continuously stirring the liquid phase for about 45 min from the dropwise addition of hydrazine monohydrate, the bubbling substantially ceased, whereupon the liquid phase became dark green.

The inventors infer that the above-mentioned dropwise addition of hydrazine monohydrate and stirring caused the reaction represented by the following chemical equation (A) to proceed within the glass vessel. However, the reaction mechanism within the glass vessel is not limited to the chemical equation (A).

V₂O₅+6H₃PO₄+(½)NH₂NH₂→(½)V₂O₅+VO₂+(NH₄)₂HPO₄+5H₃PO₄+(¼)O₂ (A)

The generation of (¼)O₂ on the right side of equation (A) corresponds to the bubbling.

To the liquid phase whose color was turned into dark green by the dropwise addition of hydrazine monohydrate and stirring, 4.24 g of LiOH·H₂O were added over about 10 min. The pH of the liquid phase immediately after adding LiOH·H₂O thereto was 3. As LiOH·H₂O was added, the liquid phase changed its color into navy blue, while its pH stabilized at 2.5. The mixed liquid of Example 1 was obtained by the foregoing procedure.

While the inside of the glass vessel containing the above-mentioned mixed liquid of Example 1 and a 35-mm football-shaped rotator was stirred with a high-power magnetic stirrer, the mixed liquid was started to be heated with an autoclave, so that the temperature of the mixed liquid was raised to 250° C. The pressure within the closed glass vessel was raised by the steam generated upon heating. Thus, the hydrothermal synthesis step held the mixed liquid within the glass vessel at 250° C. for 81 hr under pressure. The pressure within the glass vessel was held at 3.6 MPa. When heating the mixed liquid, the steam leaked at about 190° C., whereupon the inside of the glass vessel was left to cool down to about 60° C., then its packing was replaced, the glass vessel was refastened, and the mixed liquid was reheated. At the moment when the glass vessel was refastened, about ⅓ to ½ of the water content had evaporated from the mixed liquid since the starting of overheating.

After stopping heating the mixed liquid, the temperature within the glass vessel was naturally cooled to 28° C. It took about 5 hr for the temperature within the glass vessel to drop to 28° C. after stopping heating. The mixture within the glass vessel was a navy-blue solution with a green precipitate. The pH of the navy-blue solution was 1.

The glass vessel was left to stand still, and the supernatant was removed from within the vessel. Further, about 200 ml of distilled water were added into the vessel and stirred, so as to wash the inside of the vessel. After the washing by stirring, the pH of the solution was 2. The glass vessel was left to stand still, and the supernatant was removed from within the vessel. The washing by stirring with distilled water and removal of the supernatant was further repeated two times, whereupon the pH of the solution became 4, whereby particles were harder to precipitate from within the solution. Subsequently, the solution was filtered under suction. After the filtration, a green precipitate left on the filter paper was washed with water and subsequently with about 100 ml of acetone, and then filtered under suction again. The residue remaining after the filtering was semidried and then transferred to a stainless Petri dish, on which it was dried for 15.5 hr at room temperature in a vacuum.

The foregoing hydrothermal synthesis step yielded 10.55 g of a green solid as the active material of Example 1. The weight of the green solid, when converted into LiVOPO₄, was seen to correspond to 62.5% of the yield of 16.89 g of LiVOPO₄ assumed at the time of compounding the materials.

The inventors infer that the reaction represented by the following chemical equation (B) proceeded within the glass vessel between the moment when LiOH·H₂O was added to the liquid phase turned into dark green by the dropwise addition of hydrazine monohydrate and stirring as mentioned above and the moment when the heating and pressurizing of the mixed liquid by the autoclave was completed. However, the reaction mechanism within the glass ⁻vessel is not limited to the chemical equation (B).

(½)V₂O₅+VO₂(NH₄)₂HPO₄+5H₃PO₄+2LiOH→LiVOPO₄+H₂O+(NH₄)₂HPO₄+4H₃PO₄+(½)V₂O₅+LiOH (B)

### EXAMPLES 2 to 7 AND COMPARATIVE EXAMPLES 1 to 4

In Examples 2 to 7 and Comparative Examples 1 to 4, [Li]/[V] and [P]/[V] were adjusted to the values listed in Table 1. The compounds listed in Table 1 were used as reducing agents in Examples 2 to 7 and Comparative Examples 1 to 4. Comparative Examples 1 and 2 used no reducing agent. In Examples 2 to 7 and Comparative Examples 1 to 4, the pH of the mixed liquid immediately before heating with the autoclave (hereinafter referred to as “pH_{before}”) in the hydrothermal synthesis step was as listed in Table 1. In Examples 2 to 7 and Comparative Examples 1 to 4, the pH of the mixed liquid after the hydrothermal synthesis step before washing (hereinafter referred to as “pH_{after}”) was as listed in Table 1.

The active materials of Examples 2 to 7 and Comparative Examples 1 to 4 were obtained as in Example 1 except for the foregoing matters.

Measurement of Crystal Structure

As a result of Rietveld analysis according to powder X-ray diffraction (XRD), the active materials of Examples 1 to 7 and Comparative Examples 1 to 4 were seen to contain β-type crystal phases of LiVOPO₄.

Measurement of L and S

The active material of Example 1 was observed with an SEM. FIG. 1 illustrates a photograph of the active material of Example 1 taken through the SEM. As illustrated in FIG. 1, the active material of Example 1 was seen to be a rod-shaped particle group having the β-type crystal structure of LiVOPO₄. By observations through the SEM, the minor axis length and major axis length were measured in each of 100 particles in Example 1. The measured values of minor axis length were averaged, so as to determine an average minor axis length S of the particle group in Example 1. The measured values of major axis length were averaged, so as to determine an average major axis length L of the particle group in Example 1. Table 1 lists the S, L, and L/S of Example 1.

When measured as in Example 1, each of the active materials of Examples 2 to 7 and Comparative Example 3 .was seen to be a rod-shaped crystal group having the β-type crystal structure of LiVOPO₄. When measured as in Example 1, each of the active materials of Comparative Examples 1, 2, and 4 was seen to be a crystal group having the β-type crystal structure of LiVOPO₄ but not shaped like rods. Table 1 lists the respective particle forms of Examples 2 to 7 and Comparative Example 1 to 4.

Table 1 lists S, L, and L/S of Examples 2 to 7 and

Comparative Examples 1 to 4 measured as in Example 1.

Making of Evaluation Cells

The active material of Example 1 and a mixture of polyvinylidene fluoride (PVDF) and acetylene black as a binder were dispersed in N-methyl-2-pyrrolidone (NMP) acting as a solvent, so as to prepare a slurry. The slurry was prepared such that the active material, acetylene black, and PVDF had a weight ratio of 84:8:8 therein. This slurry was applied onto an aluminum foil serving as a current collector, dried, and extended under pressure, so as to yield an electrode (positive electrode) formed with an active material layer containing the active material of Example 1.

Then, thus obtained electrode and an Li foil as its counter electrode were mounted on each other with a separator made of a polyethylene microporous film interposed therebetween, so as to yield a multilayer body (matrix). This multilayer body was put into an aluminum-laminated pack, which was then sealed in a vacuum after a 1-M LiPF₆ solution as an electrolytic solution was injected therein, so as to make an evaluation cell of Example 1.

Evaluation cells singly using the respective active materials of Examples 2 to 7 and Comparative Examples 1 to 4 were made as in Example 1.

Measurement of Discharge Capacity

Using the evaluation cell of Example 1, the discharge capacity (in the unit of mAh/g) at a discharging rate of 0.01 C (a current value at which constant-current, constant-voltage charging at 25° C. completed in 100 hr) was measured. Table 1 lists the result of measurement. Using the evaluation cell of Example 1, the discharge capacity (in the unit of mAh/g) at a discharging rate of 0.1 C (a current value at which constant-current, constant-voltage charging at 25° C. completed in 10 hr) was also measured. Table 1 lists the result of measurement.

The discharge capacity in each of the evaluation cells of Examples 2 to 7 and Comparative Examples 1 to 4 was measured as in Example 1. Table 1 lists the results of measurement.

Evaluation of the Rate Characteristic

The rate characteristic (in the unit of %) of Example 1 was determined. The rate characteristic is the ratio of discharge capacity at 0.1 C when the discharge capacity at 0.01 C is taken as 100%. Table 1 lists the results. Greater rate characteristic is more preferred.

The rate characteristic in each of the evaluation cells of Examples 2 to 7 and Comparative Examples 1 to 4 was determined as in Example 1. Table 1 lists the results.

TABLE 1

| | | | | | | | | | | Evaluation cell | | |
|---|---|---|---|---|---|---|---|---|---|---|---|---|
| | | | | | | | | | | Discharge | | |
| | Hydrothermal synthesis step | | | | | Particle group | | | | capacity | | Rate |
| | | | Reducing | | | | L | S | | (mAh/g) | | characteristic |
| | [Li]/[V] | [P]/[V] | agent | pH_{before} | pH_{after} | Form | (μm) | (μm) | L/S | 0.01 | 0.1 C | (%) |
| Example 1 | 1 | 3 | hydrazine | 2.5 | 1 | rod | 12 | 3.4 | 3.5 | 143 | 133 | 93.0 |
| Example 2 | 1 | 2 | hydrazine | 3.5 | 1 | rod | 5 | 2.2 | 2.3 | 140 | 117 | 83.6 |
| Example 3 | 1 | 5 | hydrazine | 2 | 1 | rod | 13 | 2.5 | 5.1 | 138 | 122 | 88.4 |
| Example 4 | 1 | 8 | hydrazine | 2 | 1 | rod | 15 | 2.3 | 6.5 | 133 | 111 | 83.5 |
| Example 5 | 1 | 9 | hydrazine | 2 | 1 | rod | 16 | 2 | 8 | 130 | 105 | 80.8 |
| Example 6 | 1.1 | 3 | hydrazine | 2.5 | 1 | rod | 10 | 3.6 | 2.8 | 141 | 130 | 92.2 |
| Example 7 | 0.9 | 3 | hydrazine | 2.5 | 1 | rod | 8 | 3.9 | 2.1 | 135 | 120 | 88.9 |
| Comparative | 1 | 3 | none | 3 | 3 | indefinite | 1.1 | 0.9 | 1.2 | 29 | 12 | 41.4 |
| Example 1 | | | | | | | | | | | | |
| Comparative | 1 | 1 | none | 7 | 7 | particulate | 1 | 0.7 | 1.4 | 36 | 28 | 77.8 |
| Example 2 | | | | | | | | | | | | |
| Comparative | 1 | 11 | hydrazine | 2 | 1 | rod | 18 | 1.5 | 12 | 112 | 85 | 75.9 |
| Example 3 | | | | | | | | | | | | |
| Comparative | 1 | 1.8 | hydrazine | 3.5 | 1 | particulate | 3.5 | 2.6 | 1.4 | 110 | 92 | 83.6 |
| Example 4 | | | | | | | | | | | | |

As clear from Table 1, Examples 1 to 7 yielded the active materials by a manufacturing method comprising a hydrothermal synthesis step of heating a mixed liquid containing a lithium source, a phosphate source, a vanadium source, water, and a reducing agent under pressure. In Examples 1 to 7, [P]/[V] was adjusted to 2 to 9 in the hydrothermal synthesis step.

As listed in Table 1, each of the active materials of Examples 1 to 7 was seen to be a rod-shaped particle group having the β-type crystal structure of LiVOPO₄ with the average minor axis length S of 1 to 5 μm, average major axis length L of 2 to 20 μm, and L/S of 2 to 10.

As listed in Table 1, the discharge capacity in each of the evaluation cells of Examples 1 to 7 was seen to be greater than that in any of the comparative examples. The rate characteristic in each of the evaluation cells of Examples 1 to 7 was seen to tend to be better than that in any of the comparative examples.

### REFERENCE SIGNS LIST

10 . . . positive electrode; 20 . . . negative electrode; 12 . . . positive electrode current collector; 14 . . . positive electrode active material layer; 18 . . . separator; 22 . . . negative electrode current collector; 24 . . . negative electrode active material layer; 30 . . . power generating element; 50 . . . case; 60, 62 . . . lead; 100 . . . lithium-ion secondary battery

What is claimed is:

1. An active material containing a rod-shaped particle group having a β-type crystal structure of LiVOPO₄;
wherein the particle group has an average minor axis length S of 1 to 5 μm, an average major axis length L of 2 to 20 μm, and L/S of 2 to 10.

2. A lithium-ion secondary battery having a positive electrode comprising a positive electrode current collector and a positive electrode active material layer disposed on the positive electrode current collector;
wherein the positive electrode active material layer contains the active material according to claim 1.

3. A method of manufacturing an active material, the method comprising a hydrothermal synthesis step of heating a mixture containing a lithium source, a phosphate source, a vanadium source, water, and a reducing agent under pressure;
wherein the hydrothermal synthesis step adjusts the ratio [P]/[V] of the number of moles of phosphorus [P] contained in the mixture before heating to the number of moles of vanadium [V] contained in the mixture before heating to 2 to 9.

4. A method of manufacturing an active material according to claim 3, wherein the hydrothermal synthesis step adjusts the ratio [Li]/[V] of the number of moles of lithium [Li] contained in the mixture before heating to [V] to 0.9 to 1.1.
